(19) United States
(12) Patent Application Publication
(10) Pub. No.: US 2003/0158914 A1
(43) Pub. Date: Aug. 21, 2003

(54) Access control method and system

(76) Inventors: Mitsunori Satomi, Kawasaki (JP); Atsushi Hatakeyama, Yokohama (JP)

Correspondence Address: HOGAN & HARTSON L.L.P., 500 S. GRAND AVENUE, SUITE 1900, LOS ANGELES, CA, 90071-2611, US

(21) Appl. No.: 10/136,927

(22) Filed: Apr. 30, 2002

(30) Foreign Application Priority Data
Feb. 18, 2002 (JP) 2002-039441

(51) Int. Cl. G06F 15/16

(52) U.S. Cl. 709/219

(57) ABSTRACT

A method that allows a Web system at a transition destination to effectively grasps transitions of access destinations among Web pages provided by independent Web systems. When the user changes an access destination between two Web pages, the user operates an URL link provided in a transition source Web page to change the access destination. As the URL link is operated, its HTTP request is transferred to a transition source Web system that provides the transition source Web page. The transition source Web system decides certification information according to a contract agreed with a Web system that provides a transition destination Web page that is a transition destination indicated by the URL link, and returns to the user information including identification information that specifies the transition destination Web page and the certification information.

### BACKGROUND OF THE INVENTION

1. Field of the Invention

The present invention relates to a system for accessing a plurality of Web systems connected via a network from a Web client.

2. Description of Related Art

In the Internet, contents (Web pages) described mainly in the Hypertext Markup Language (HTML) are exchanged between a Web system and Web clients according to the Hypertext Transfer Protocol (HTTP) (stipulated in RFC2626 of Internet Engineering Task Force (IETF)). The HTTP protocol basically provides a system that starts communication (connection) anew each time a set of contents is transferred and closes the communication (connectionless) upon completion of the transfer. At least one Web server composes one system (hereafter referred to as a “Web system”) that provides services to the users.

As the Internet has come into wide use in recent years, technical preparation for providing services and effective billing systems for the services on the Internet have become urgent necessity.

One of such technologies pertains to services that provide Web pages that display a collection of guidance to a variety of information on the Internet and allow the users to readily access needed information. So-called community sites and portal sites are representatives of those that provide such services.

These sites may be connected in a manner that, for example, one service provider site can provide services to the users who are members of a community site and provide different services to the users who are not the members. In this case, the service provider site requires judging whether the users who access the information provided by the service provider site are members of the community site. However, there are cases that the community site cannot disclose its own membership information to the service provider site.

To meet these requirements, whether or not information provided by the community site has been referred to may be checked prior to accessing the service provider site. One of the methods to check the status uses a Referer field (hereafter referred to as a “Referer”) of a request header included in an HTTP request.

According to a dictionary definition in “Communication Protocol Dictionary” edited by Kasano, Hidematsu, First edition, Third Print, p.559, 1997, ASCII corporation, a “Referer” is a piece of information that is embedded by a Web browser of a Web client in an HTTP request that is transmitted to the server from the Web browser of the Web client, which is URL information of a Web page (a transition resource Web page) that has been accessed before.

However, there is a problem in that the user can change the Referer by a variety of devices and can transmit to the Web server a HTTP request that includes a Referer different from the URL of the actual transition resource Web page.

### SUMMARY OF THE INVENTION

The present invention relates to a method for effectively grasping transitions of access destinations between Web pages from one Web system to another Web system by the user using a Web client.

In a Web system that is connected to Web clients through a network, and provides Web pages, such as the Internet, the Web system provides, to the user who uses one of the Web clients (transition resource Web pages), Web pages including information that allows the user to select destination Web pages to which accesses are shifted (hereafter referred to as “transition destination Web pages”); upon reference by the Web client, decides identification information (for example, URL) and certificate information (hereafter referred to as “tokens”) that specify a transition destination Web page in response to a change request issued from the Web client to change the access destination, which corresponds to a selection of the transition destination Web page; and transfers information including tokens (for example, an HTTP response) to the Web client.

Also, in transitions of access destinations among Web pages within the same Web system, a token may be issued in each Web page to specify a transition by the user of an access destination among Web pages.

It is noted that the system described above can be achieved by a program that realizes the functions described above. Also the system can be achieved by a recording medium that stores such a program.

### BRIEF DESCRIPTION OF THE DRAWINGS

FIG. 1 shows a diagram illustrating the relation among components in accordance with a first embodiment of the present invention.

FIG. 2 shows a flowchart indicating process flows in the first embodiment.

FIG. 3 shows a re-direct method of an HTTP response.

FIG. 4 shows a re-direct method using a refreshing operation of the HTML.

FIG. 5 shows a diagram illustrating the relation among components in accordance with a second embodiment of the present invention.

FIG. 6 shows a data structure of a contents corresponding table.

FIG. 7 shows a diagram illustrating the relation among components in accordance with a third embodiment of the present invention.

FIG. 8 shows a diagram illustrating the relation among components in accordance with a fourth embodiment of the present invention.

FIG. 9 shows a diagram illustrating the relation among components in accordance with a fifth embodiment of the present invention.

FIG. 10 shows relations when a plurality of portal sites and service companies in accordance with the fifth embodiment are present.

### DETAILED DESCRIPTION OF THE PREFERRED EMBODIMENTS

Preferred embodiments of the present invention will be described below with reference to the accompanying drawings. The embodiments represent only examples and do not limit the present invention.

### First Embodiment

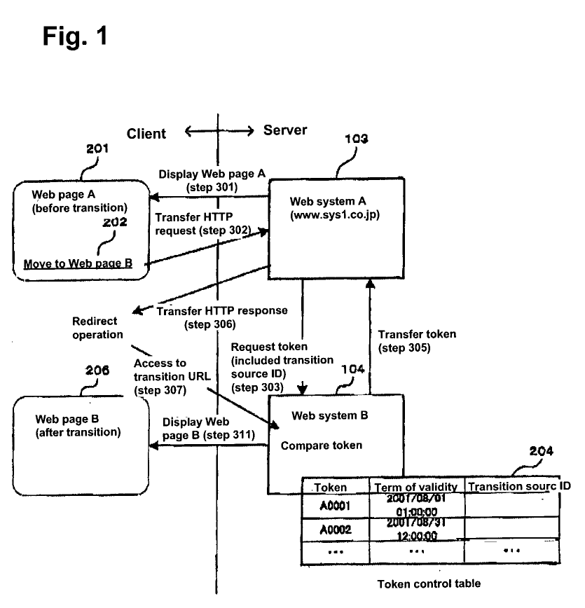

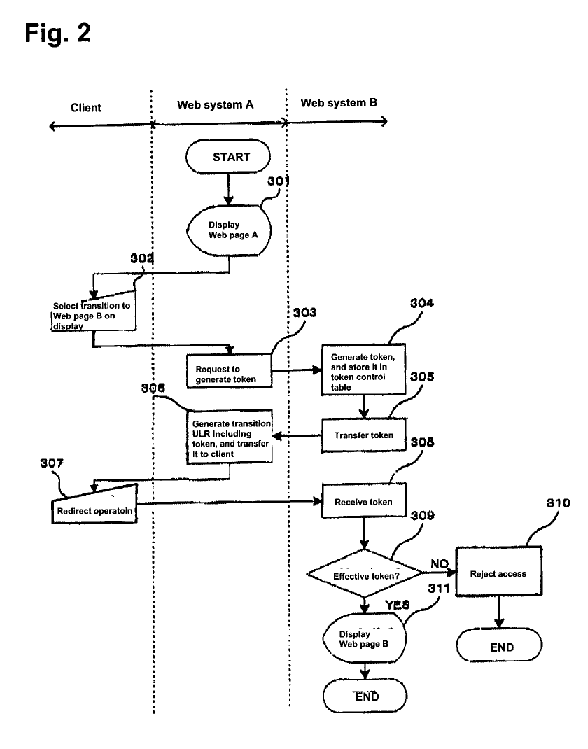

A first embodiment of the present invention is described in detail with reference to FIGS. 1 and 2.

FIG. 1 shows a diagram illustrating the relation among components in accordance with the first embodiment of the present invention. FIG. 2 shows a flowchart indicating process flows in the first embodiment. FIG. 2 shows an operation in which the user using a Web client shifts an access destination from a Web page A 201 provided by a Web system A 103 to a Web page B 206 provided by a Web system B 104. In the present embodiment, the Web client is connected to the Web system A 103 and the Web system B 104 through a network (not shown).

As the user uses the Web client to access the Web system A 103, and the Web page A 201 is presented to the Web client (step 301). When the user selects an URL link 202 to the Web page B 206 existing on the Web page A 201, a HTTP request is transferred from the Web client to the Web system A 103 (step 302).

As the Web system A 103 receives the HTTP request from the Web client, the Web system A 103 makes a request to provide a token to the Web system B 104 (step 303). The token is information that allows the user to access the Web system B 104.

The Web system B 104 generates a token, and stores an identification (a transition source ID) to identify the Web system A 103 that is a request source and the term of validity of the token formed in association with the token in a token control table 204 (step 304), and transfers the generated token to the Web system A 103 (step 305).

The Web system A 103 embeds the received token in a transition URL and transmits the same to the Web client as an HTTP response (step 306). The Web client accesses the Web system B 104 according to the received transition URL (step 307).

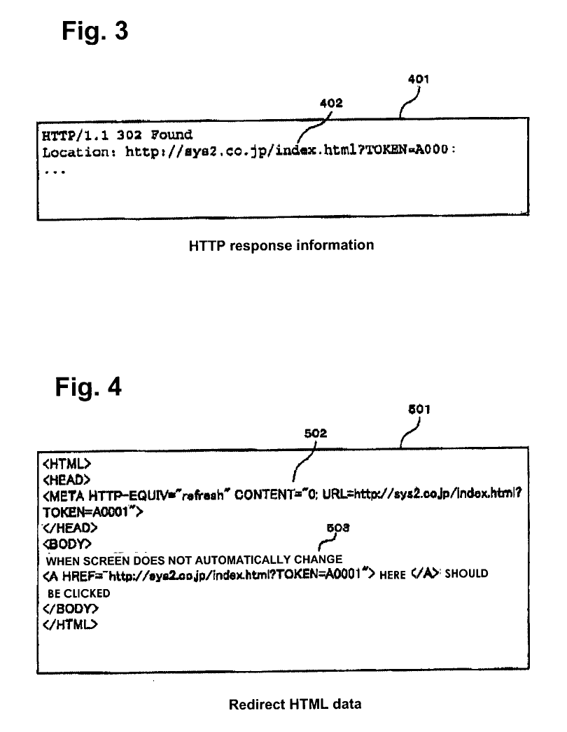

The HTTP response 401 shown in FIG. 3 realizes one system of HTTP redirection employed in the present embodiment. The HTTP response 401 includes therein an instructive response code to make an automatic access from the Web client to another Web page (a section “302” in the first line in FIG. 3) and a URL 402 of that access destination.

Another system to make the Web client to access the Web system B 104 will be described with reference to FIG. 4. This system is provided with a method using an HTML refreshing operation, and HTML data 501 is data for performing the operation.

The HTML data 501 includes data 502 indicating an instruction to make an automatic access from the Web client to a designated URL, and an RUL link 503 that enables an access even by an instruction from the user when an automatic access cannot be made.

It may be convenient to the user if the URL link 503 is included as indicated in FIG. 4 when an automatic transition is not made. However, an error message can be displayed in such a case. In the latter case, the fact that the HTML data 501 does not include the URL link 503 lowers the possibility that the user can see the token.

The Web system B 104 that is accessed through using the transition URL extracts information from the token to make verification (step 308).

Descriptions are made with reference to FIG. 2 on the assumption that the token can be received. However, when the token cannot be received in step 308, such incidence may be processed thereafter in a manner similar to the case when the token is determined to be invalid (step 310).

The Web system B 104 compares the received token with the token control table 204, and judges its validity according to the term of validity recorded in the token control table 204 (step 309). When the time at which the validity is judged has passed the term of validity of the token, a determination is made that the token is invalid.

When the token is determined to be valid, the information of the token is erased from the token control table 204, and information of the Web page B 206 is transferred to the Web client.

When the Web system B 104 judges that the token is invalid, the Web system B 104 proposes to the Web client by sending to the Web client a Web page containing a massage indicating that the HTTP request is terminated and an access cannot be made, to thereby make the Web client to display that an access cannot be made to the Web system B 104 (step 310).

When the Web system B 104 judges that the token is invalid, and the token control table 204 contains information relating to the token, that information is erased.

In the present embodiment, the token control table 204 is managed by the Web system B 104. However, in step 309 in which the Web system A 103 manages the token control table 204 to judge the validity of the token, the Web system B 104 may inquire the Web system A 103 about the contents of the token control table 204.

Also, the Web system A 103 may associate the transfer history of the token with a transition destination Web system (e.g., the Web system B 104 in the present embodiment) and stores such transfer history. By doing so, the Web system A 103 can later know transition destination Web systems that the user using the Web client has accessed.

In the present embodiment, the Web system B 104 generates the token. However, the token may be generated by the Web system A 103, and the generated result may be transferred to the Web system B 104 and stored in the token control table 204.

In the present embodiment, each of the Web systems on the transition destination side and the transition source side may have a token generation algorism according to a certain protocol agreed by the Web systems, and the token and the validity information may be transferred fro the Web system A 103 to the Web system B 104 by the transition URL 205, such that the Web systems do not communicate with each other.

In this case, a public key encryption system may be used, and the transition URL 205 may be digitally signed, such that the Web system B 104 can check whether or not the transition ULR has been altered. In this instance, the BASE 64 technology may be used to convert the binary data of the digital signature into a character string, which may be included in the transition URL. Also, the present embodiment can also be achieved in a system in which only a part of the transition URL 205, for example, only the token information is digitally signed.

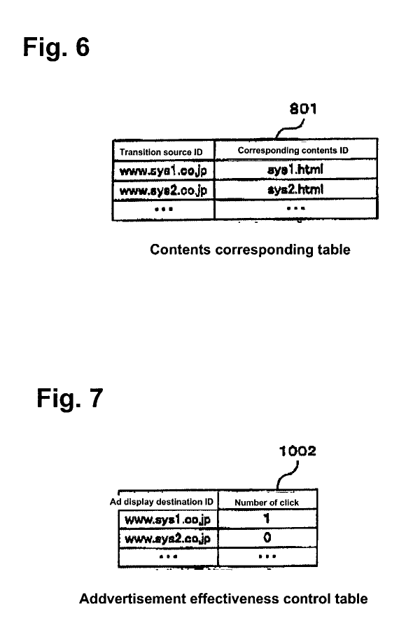

Also, the Web system B 104 may be provided with a contents corresponding table 801 shown in FIG. 6 to manage correspondence of Web pages (contents) provided by transition source Web systems. The contents corresponding table 801 is composed of transition source IDs indicating transition source Web systems and corresponding contents IDs representing Web pages that would be provided to the users who transfer access destinations from these transition source Web systems.

In the embodiment in which the users are discriminated by the use of the contents corresponding table 801, the validity of a token is checked, a transition source ID in the token control table 204 is then searched from the contents corresponding table 801, and a corresponding contents ID representing a Web page to be provided to the user is decided. The Web system B 104 transfers a Web page B 802 corresponding to the corresponding contents ID to the user.

As described above, the present embodiment is capable of providing a function to effectively change Web pages provided by a transition destination Web system according to a transition source Web system.

In the present embodiment, a transition source ID is given in a unit of a transition source Web system. However, it is obvious that a transition source ID can be given in a more detailed unit, such as, for example, in a unit of a Web page.

It is noted that the access control method in accordance with the present invention can be implemented in software. For example, the Web system A 103 may be provided with a storage medium that stores a computer program, the program may be read by a reading device provided in the Web system A 103 and executed. Alternatively, the program may be transferred to the Web system A 103 through a communication network such as the Internet and executed.

As described above, in accordance with the present embodiment, both of the Web system A 103 on the transition source side and the Web system B 104 on the transition destination side can appreciate that the user using the Web client changes its access destination from the Web system A 103 to the Web system B 104.

### Second Embodiment

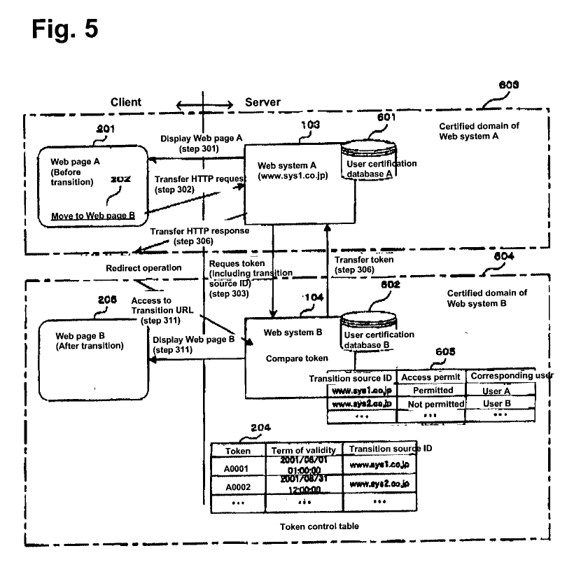

FIG. 5 shows a structure of an access control system in accordance with a second embodiment of the present invention. Referring to FIG. 5, the structure of the access control system will be described. The second embodiment relates to an access control method in Web systems each having a mechanism to individually perform user certification.

A Web system A 103 has a mechanism to perform a user certification within the range of Web pages that the Web system A 103 itself provides, and a user certification database A 601. By using these mechanism and the data base, the Web system A 103 performs a certification against the user who tries to access at least a part of the Web pages provided by the Web system A 103.

The region of Web pages that needs a certification is defined as a certificated domain 603 of the Web system A 103. When the user accesses a Web page included in the certificated domain 603, the user is required to present information including a proper user ID and a password. Unless the information is certified, the user cannot use the Web system A 103.

A Web system B 104 also has a mechanism to perform a user certification and a user certification database B 602 to thereby compose a certificated domain 604. In addition, the Web system B 104 has an access control table 605 that indicates from which Web systems transitions are permitted.

In FIG. 5, the certificated domain 603 of the Web system A 103 and the certificated domain 604 of the Web system B 104 include a Web page A 201 and a Web page B 206, respectively. However, not all Web pages to be provided by each of the Web systems need to be included in the respective certificated domain, and each of the Web systems may provide Web pages that are not included in the respective certificated domain.

The access control table 605 is composed of transition source IDs indicating transition source Web systems, information as to whether or not accesses from the corresponding transition source Web systems are permitted, and information as to which of the users in the user certification database B 602, when permissions are granted, are related with.

It is noted, however, that the access control table 605 may have any structure that can relate transition source IDs to access permissions, and therefore is not limited to the structure described above. For example, access permissions may be stored while being associated with corresponding users, and transition source IDs may be stored while being associated with corresponding users. By appropriately referring to these associations, transition source IDs and access permissions may be related to one another. In this case, the relation between the existing login IDs and access rights can be used.

In the second embodiment, its process flow is generally the same as that shown in FIG. 2. However, it differs from the first embodiment in that it has an additional step of searching for transition source IDs in the token control table 204 from the access control table 605, and judging as to whether or not accesses to the Web system B 104 are permitted. When the access is permitted, the Web page B is displayed (step 311). However, when the access is not permitted, the access is denied (step 310).

The step of searching for transition source IDs from the access control table 605 may be added, for example, after the Web system B 104 judges the validity of the token (step 309).

In the present embodiment, the token control table 204 is generated, and a determination is made, by searching for a transition source ID in the token control table from the access control table 605, as to whether or not access permission is present. However, upon receipt of a token request from the Web system A 103, a determination may be made, by referring to the access control table 605, as to whether or not access permission of the Web system A 103 is present, to thereby make a judgment as to whether or not a token can be issued.

In the present embodiment, without registering information about the user stored in the user certification database A 601 in the user certification database B 602, Web pages in the certificated domain 604 of the Web system B 104 can be provided to the user of the Web system A 103.

In accordance with the present embodiment, the data for user certification does not need to be disclosed from the Web system A 103 to other Web systems. As a result, the use of Web pages of the Web system B 104 is available to the user on the side of the Web system A 103, without disclosing important user information (e.g., customer information).

### Third Embodiment

Referring to FIGS. 1 and 7, a description will be made as to an embodiment example in which the system of the first embodiment is applied to a banner advertisement system formed by a plurality of Web systems.

A banner advertisement system provides a mechanism in which images and characters for advertisement (i.e., a banner advertisement) are presented by an advertiser on a Web page, and when the user clicks (selects) the advertisement, the user is guided to a Web page of the advertiser.

A Web system A 103 provides to the user a Web page A 201 that displays an URL link 202 as a banner advertisement, as indicated in FIG. 1. A description will be made below assuming that the URL link 202 is a banner advertisement. In FIG. 1, the banner advertisement 202 is indicated as an URL link in a character string. However, the banner advertisement 202 can be anything that can be expressed in the HTML, such as images or FORMs in the HTML.

In the present embodiment, the Web system B 104 records destinations to display the banner advertisement 202 and the number of clicks on that banner advertisement 202 in an advertisement effectiveness control table 1002 shown in FIG. 7. The advertisement effectiveness control table 1002 is composed of transition source IDs indicating transition source Web systems, and the click numbers retaining how many times the banner advertisement is selected in each of the transition sources.

The present embodiment example operates generally according to the flowchart shown in FIG. 2. However, a difference is that it has a step of searching for advertisement display destination IDs within the advertisement effectiveness control table 1002, which may correspond to transition source IDs in the token control table 204, and adding one to the number of clicks at the corresponding advertisement display destination ID. It is noted that the token control table 204 may be provided in the Web system A 103.

In the present embodiment, a transition source Web system and the number of accesses from the transition source Web system can be effectively specified. Accordingly, without requiring a third party organization that is not a transition destination or a transition source, which is equivalent to an advertisement agent, the transition source Web system can calculate the reward for the advertisement based on the number of accesses.

Also, at the transition source, the user can click the banner advertisement 202 to thereby grasp the number of accesses at the transition destination Web page who is the advertiser. Accordingly, both of the transition source that is the advertisement display destination and the transition destination that is the advertiser can check the number of clicks.

### Fourth Embodiment

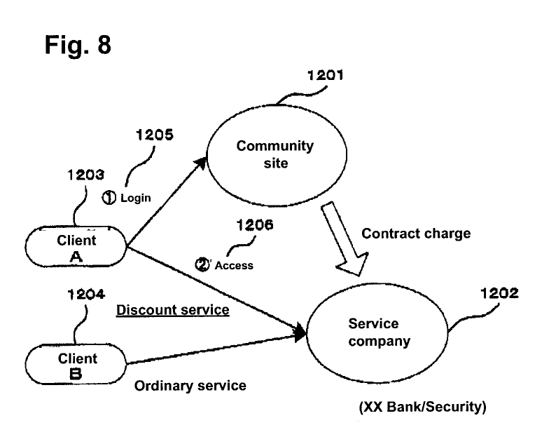

FIG. 8 shows a structure of a fourth embodiment of the present invention. The structure of the fourth embodiment will be described in detail with reference to FIG. 8. The present embodiment relates to an access control that is applied to a system in which discount service is provided exclusively to participants of a specified community.

A community site 1201 is an aggregation of Web systems that can be used by an aggregation of specified users (for example, employees of a company), and has a mechanism to perform a user certification to identify the users who are participants of the community site 1201. One example of the user certification mechanism is indicated in the second embodiment. A client A 1203 is a Web client that is used by the user who is a participant of the community site 1201.

A service company 1202 makes a contract with the community site 1201 that provides special discount service (discounts on the charges for usage) to the participants of the community site 1201. On the other hand, a client B 1204 is a Web client that is used by a general user who cannot receive the discount service.

The user who is a participant of the community site 1201 uses the client A 1203 to login the community site 1201 (a login request 1205), and then accesses the service company 1202 according to a transition URL including a token received from the community site 1201 (an access request 1206).

In the present embodiment, the service company 1202 is capable of making a judgment as to whether an access is made from a participant of the community site 1201 (the user who uses the client A 1203) or whether an access is made from an ordinary user (the user who uses the client B 1204). Accordingly, the service company 1202 can provide services to the client A 1203, such as, transferring information about the discount service.

In other words, without having to obtain from the community site 1201 information about the participants of the community site 1201, the discount service information can be selectively transferred to the participants of the community site 1201.

In accordance with the present embodiment, the community site 1201 can provide the discount service provided by the service company 1202 to the participants of the community site 1201 without disclosing information of the participants to the service company 1202.

### Fifth Example

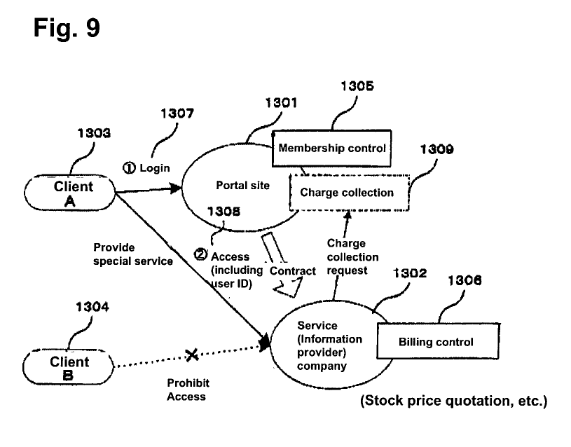

FIG. 9 shows a structure of a fifth embodiment of the present invention. The structure of the fifth embodiment will be described in detail with reference to FIG. 9. The fifth embodiment relates to an access control that is applied to a Web system formed from a service company that provides information to the users and a portal site.

A portal site 1301 has a membership control 1305 for limiting and controlling the users who can use the portal site 1301. The membership control 1305 includes a mechanism for performing a user certification to discriminate the users of the portal site 1301. The user of the portal site 1301 uses a client A 1303 to login the portal site 1301 (a login request 1307). In this instance, the membership control 1305 verifies if the user is properly authorized.

The service company 1302 that has a service contract with the portal site 1301 provides services to participants of the portal site 1301 (e.g., the user of a client A 1303), and gains the reward as a compensation for the services (the charges for usage) depending on the usage status, and has a billing control 1306 for controlling the reward. Also, the service company 1302 does not provide services to the users who do not access from the contracted portal site 1301 (e.g., the user of a client B 1304). The user of the client A 1303, who logins the portal site 1301, changes its access destination from the portal site 1301 to an individual service company 1302 (an access request 1308).

In accordance with the present embodiment, the user of the client A 1303 who makes an access to the service company 1302 in a manner described above can be determined as a participant of the portal site 1301, and thus the service company 1302 can provide the information to the client A 1303 according to the contract.

In the conventional technique, even when an access request 1308 to the service company 1302 is made, a user certification similar to the user certification required upon a login request 1307 to the portal site 1301 needs to be performed, and therefore the service company 1302 also needs to have a membership control 1305.

In the present embodiment, a user ID that is single user identification information that specifies the users at the membership control 1305 in the portal site 1301 is inserted in the access request 1308 sent to the service company 1302. Accordingly, the service company 1302 is capable of identifying the users of the services provided by the service company 1302 based on the user ID, and the service company 1302 does not require the membership control 1305.

The service company 1302 periodically provides billing information (about the users and charges for usage), which is obtained based on information of the billing control 1306, to the portal site 1301 to request to collect the charges (a charge collection 1309). It is noted that the collection of charges may be done by the service company 1302 itself, or a third party organization may be used to collect the charges.

Also, in the present embodiment, when the client A 1303 tries to access the selected service company 1302, the client A 1303 is once made to access the portal site 1301. Accordingly, the portal site 1301 can grasp which specified service companies the access destination of the user of the client A 1303 has moved through. As a result, the portal site 1301 side can check the billing information received from the service company 1302.

As described above, the present embodiment is capable of providing services to the portal site 1301 and the service company 1302 in a form in which the membership control 1305 and the billing control 1306 are respectively separated from one another.

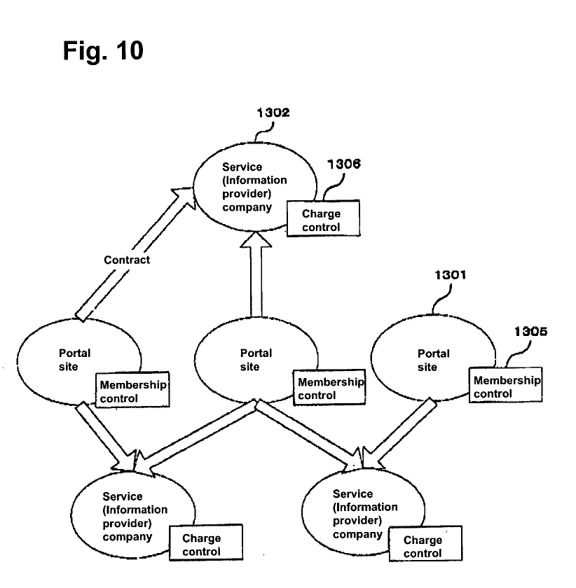

In particular, the present embodiment provides a greater advantage when the plural portal sites 1301 and the plural service companies 1302 are present as indicated in FIG. 10. Since each of the service companies 1302, in accordance with the present embodiment, does not need to have a membership control 1305, a new function does not need to be added to the service company 1302 even when the number of contracted portal sites 1301 increase.

In the present embodiment, the access request 1308 includes a user ID that singularly identifies the users at the membership control 1305. However, it is clear that the present embodiment can be achieved by using other types of IDs, such as, for example, user IDs with one-to-one correspondences or one-to-many correspondences (when billing in group units), in view of the security.

In accordance with the present invention, the users' transitions of the access destinations among Web pages provided by a Web system can be effectively grasped at transition destinations.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An access control method used at a first Web system when a Web client connected to the first Web system via a network and viewing information provided by the first Web system changes an access destination to a second Web system, the access control method comprising the steps of:
receiving from the Web client an access destination change request that requests changing an access destination to the second Web system; and
transferring to the Web client identification information that specifies the access destination and certification information responding to the access destination change request.

2. An access control method according to claim 1, wherein the certification information is received by the first Web system from the second Web system that is an access destination requested to change according to the access destination change request.

3. An access control method according to claim 1, wherein the first Web system transfers access destination change instruction information to the Web client, the access destination change instructing information indicating an access destination to be changed is the second Web system.

4. An access control method according to claim 3, wherein the identification information and the certification information transferred to the Web client are included in the access destination change instructing information.

5. An access control method according to claim 1, wherein the first Web system stores the certification information transferred to the Web client and identification information of the Web client associated with the certification information.

6. An access control method used at a first Web system when a Web client connected to the first Web system via a network and viewing information provided by the first Web system changes an access destination to a second Web system, the access control method comprising the steps of:
receiving from the Web client an access destination change request that requests changing an access destination to the second Web system; and
transferring to the Web client access destination change instruction information indicating that the Web client changes an access destination to the second Web system.

7. An access control method used at a Web system that provides first and second information when a Web client connected to the Web system via a network and viewing the first information changes an access destination to the second information, the access control method comprising the steps of:
receiving from the Web client a reference information change request that requests changing information to be accessed; and
transferring to the Web client identification information that specifies the second information and certification information responding to the reference information change request.

8. An access control system used at a first Web system when a Web client connected to the first Web system via a network and viewing information provided by the first Web system changes an access destination from the first Web system to a second Web system, the access control system comprising:
a receiver device that receives from the Web client an access destination change request that requests changing an access destination to the second Web system; and
a transfer device that transfers to the Web client identification information that specifies the access destination and certification information responding to the access destination change request.

9. An access control system according to claim 8, wherein the first Web system receives the certification information from the second Web system that is an access destination requested to change according to the access destination change request.

10. An access control system according to claim 8, wherein the first Web system transfers access destination change instruction information to the Web client, the access destination change instructing information indicating an access destination to be changed is the second Web system.

11. An access control system according to claim 10, wherein the identification information and the certification information transferred to the Web client are included in the access destination change instructing information.

12. An access control system according to claim 8, wherein the first Web system stores the certification information transferred to the Web client and identification information of the Web client associated with the certification information.

13. A program that operates a computer to execute a procedure of an access control at a first Web system when a Web client connected to the first Web system via a network and viewing information provided by the first Web system changes an access destination to a second Web system, the programs comprising the steps of:
receiving from the Web client an access destination change request that requests changing an access destination to the second Web system; and
transferring to the Web client identification information that specifies the access destination and certification information responding to the access destination change request.

14. An access control method used at a second Web system when a Web client connected to a first Web system via a network and viewing information provided by the first Web system changes an access destination to the second Web system, the access control method comprising the steps of:
transferring certification information to the first Web system in response to a certification information obtaining request from the first Web system;
receiving from the Web client an access request that requests the second Web system to provide information; and
recognizing information relating to the certification information from the access request.

15. An access control method according to claim 14, further comprising the step of transferring to the Web client information indicating that an access is not possible when the information relating to the certification information is not recognized based on the access request.

16. An access control method according to claim 14, further comprising the step of storing the transferred certification information and identification information that specifies the first Web system associated with the certification information, and checking a correspondence between the recognized information relating to the certification information and the stored information to confirm a change of an access destination from the first Web system associated with the certification information.

17. An access control method used at a Web client when the Web client connected to a first Web system via a network and viewing information provided by the first Web system changes an access destination to the second Web system, the access control method comprising the steps of:
transferring to the first Web system a request to change the access destination based on information provided by the first Web system;
receiving from the first Web system a transition instruction including identification information that specifies the second Web system and certification information responding to the request to change the access destination; and
accessing the second Web system, using the received certification information.

18. An access control method used at a first Web system when a Web client connected to the first Web system via a network and viewing information provided by the first Web system changes an access destination to a second Web system, the access control method comprising the steps of:
receiving from the Web client an access destination change request that requests changing an access destination to the second Web system;
requesting the second Web system for certification information based on the received access destination change request;
receiving certification information from the second Web system;
storing identification information that specifies the access destination and the certification information associated with the identification information; and
transferring to the Web client the identification information and the certification information responding to the access destination change request.

19. An access control system used at a first Web system when a Web client connected to the first Web system via a network and viewing information provided by the first Web system changes an access destination to a second Web system that provides services via the network, the access control system comprising:
a storage device that stores user identification information that discriminates the user who uses the Web client and information including the number of usage of the services provided by the second Web system;
a device that receives from the Web client an access destination change request that requests changing an access destination to the second Web system;
a device that adds a number to the number of usage of the services in response to the access destination change request;
a device that transfers to the Web client identification information that specifies the access destination, certification information responding to the access destination change request and the user identification information; and
a device that charges the user for the use of the services according to the number of usage of the services stored.

20. An access control method used when a Web client connected to a first Web system via a network and viewing information provided by the first Web system changes an access destination to a second Web system, the access control method comprising the steps of:
at the Web client, transferring to the first Web system an access destination change request based on information provided by the first Web system;
at the first Web system, receiving from the Web client the access destination change request that requests changing a destination to the second Web system, and transferring to the second Web system a certification information obtaining request that requests certification information in response to the access destination change request;
at the second Web system, transferring to the first Web system certification information in response to the certification information obtaining request transferred from the first Web system;
at the first Web system, transferring to the Web client identification information that specifies the access destination and certification information responding to the access destination change request;
at the Web client, receiving from the first Web system a transition instruction including identification information that specifies the second Web system and certification information responding to the access destination change request, and changing an access destination to the second Web system according to the transition instruction; and
at the second Web system, receiving from the Web client an access request that requests the second Web system to provide information, and extracting information relating to the certification information from the access request.
